(19) United States
(12) Patent Application Publication
(10) Pub. No.: US 2012/0054548 A1
(43) Pub. Date: Mar. 1, 2012

(54) DATA PROCESSING DEVICE AND METHOD FOR CONTROLLING TEST PROCESS OF ELECTRONIC DEVICE USING THE SAME

(75) Inventors: XIN-QIAO TANG, Shenzhen City (CN); YANG ZHONG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/090,267

(22) Filed: Apr. 20, 2011

(30) Foreign Application Priority Data
Aug. 26, 2010 (CN) 201010263716.2

(51) Int. Cl. G06F 11/00

(52) U.S. Cl. 714/32; 714/E11.02

(57) ABSTRACT

A method for controlling a test process of an electronic device using a data processing device creates test control data to test the electronic device, selects a test item of the electronic device sequentially according to test bits in the test control data, and modifies a test bit corresponding to the selected test item to obtain modified test control data if the electronic device passes the selected test item. The method further compares the modified test control data with the created test control data if all the test items have been performed to determine if the electronic device passes the test process, and outputs a signal indicating success if the electronic device passes the test process.

### BACKGROUND

1. Technical Field

Embodiments of the present disclosure relate to test technology, and particularly to a data processing device and method for controlling a test process of an electronic device using the data processing device.

2. Description of Related Art

Motherboard testing may include a plurality of preset test items stored in a configuration file, such as a memory test, a central processing unit (CPU) test, a north bridge test, and a south bridge test. However, a test person may modify the configuration file to remove some test items, that the motherboard would otherwise fail, in order to produce false positive results. In other words the test person may cheat. Therefore, a more secure method for controlling a test process of an electronic device is desired.

### BRIEF DESCRIPTION OF THE DRAWINGS

FIG. 1 is a block diagram of one embodiment of a data processing device.

FIG. 2 is a block diagram of one embodiment of a test control system in the data processing device.

FIG. 3 is a flowchart of one embodiment of a method for controlling a test process of an electronic device using the data processing device.

FIG. 4 is an example of test control data.

### DETAILED DESCRIPTION

All of the processes described below may be embodied in, and fully automated via, functional code modules executed by one or more general purpose electronic devices or processors. The code modules may be stored in any type of non-transitory readable medium or other storage device. Some or all of the methods may alternatively be embodied in specialized hardware. Depending on the embodiment, the non-transitory readable medium may be a hard disk drive, a compact disc, a digital video disc, a tape drive or other suitable storage medium.

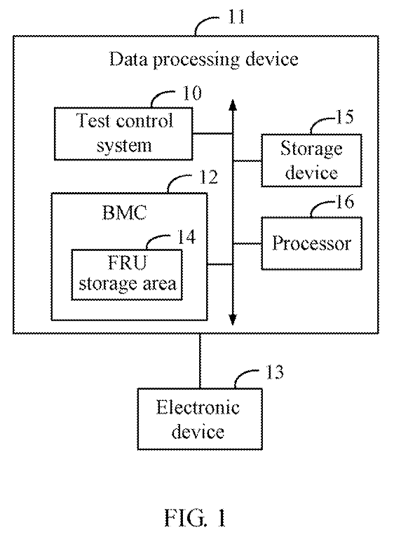

FIG. 1 is a block diagram of one embodiment of a data processing device 2, including a test control system 10, a baseboard management controller (BMC) 12, a storage device 15, and at least one processor 16. The BMC 12 includes a field replacement unit (FRU) storage area 14. The test control system 10 may be used to control a test process of an electronic device 13 or a component of the electronic device 13, such as a motherboard.

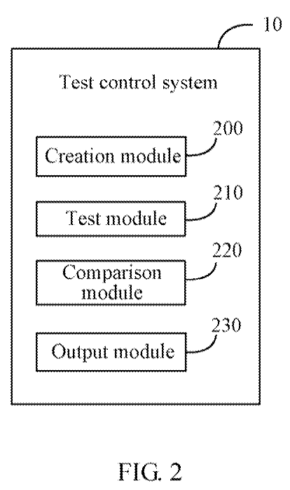

FIG. 2 is a block diagram of one embodiment of the test control system 10 in the data processing device 11. In one embodiment, the test control system 10 may include one or more modules, for example, a creation module 200, a test module 210, a comparison module 220, and an output module 230. The one or more modules 200-230 may comprise computerized code in the form of one or more programs that are stored in the storage device 15 (or memory). The computerized code includes instructions that are executed by the at least one processor 16 to provide functions for the one or more modules 200-230.

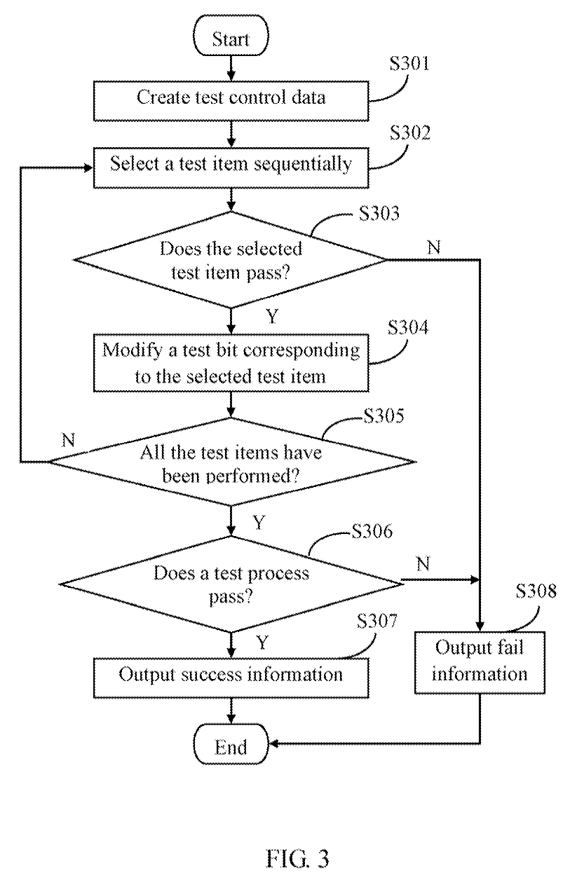

FIG. 3 is a flowchart of one embodiment of a method for controlling a test process of the electronic device 13 using the data processing device 11. Depending on the embodiment, additional blocks may be added, others removed, and the ordering of the blocks may be changed.

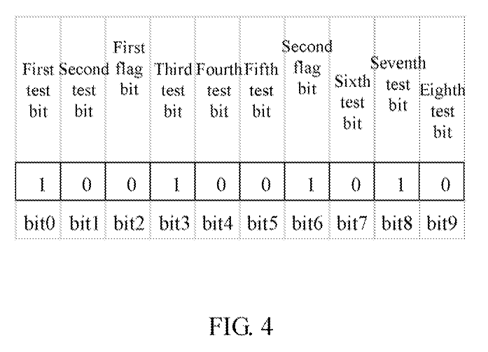

In block S301, the creation module 200 creates test control data to test the electronic device 13, and stores the test control data in the FRU storage area 14 of the BMC 12. In one embodiment, the test control data include test bits and flag bits, and each of the test bits represents a test item of the electronic device 13. The test bits and the flag bits are binary numbers. For example, the electronic device 13 includes eight test items. As shown in FIG. 4, the test control data include eight test bits, for example, from a first test bit “bit0” to a eight test bit “bit9”. Two flag bits (e.g., a first flag bit “bit2” and a second flag bit “bit6”) are stored in the test control data. In one embodiment, the flag bits are used to determine if unauthorized modification of the test items of electronic device 13 has occurred.

In one embodiment, the test bits in the test control data are arranged according to a test order of the test items of the electronic device 13. For example, the first test bit represents the first test item of the electronic device 13, and the eighth test bit represents the eighth test item of the electronic device 13. In one embodiment, the test bits in the test control data include at least one test bit which is different from the other test bits. The flag bits in the test control data are not the first bit and the last bit of the test control data. In other embodiments, a number of the flag bits may be increased according to increase of the test bits. For example, if a number of the test bits is twenty, the number of the flag bits is four.

In block S302, the test module 210 reads the test control data from the FRU storage area 14, and sequentially selects test items of the electronic device 13 according to the test bits in the test control data. In one embodiment, the test item of the electronic device 13 is selected sequentially according to the test order of the test items of the electronic device 13.

In block S303, the test module 210 determines if the electronic device 13 passes the selected test item. If the electronic device 13 passes the selected test item, the procedure goes to block S304. If the electronic device 13 fails the selected test item, the procedure goes to block S308.

In block S304, the test module 210 implements a logical NOR operation on a test bit corresponding to the selected test item to obtain modified test control data. The flag bits in the created test control data are invariant. For example, if a test bit corresponding to the selected test item in the created test control data is “1”, the test module 210 changes the test bit from “1” to “0” if the electronic device 13 passes the test item corresponding to the test bit.

In block S305, the test module 210 determines if all the test items of the electronic device 13 have been performed on the electronic device 13. If all the test items of the electronic device 13 have been performed, the procedure goes to block S306. If any test item of the electronic device 13 has not been performed, the procedure returns to block S302, the test module 210 selects the next test item in sequence that has not performed to continue the test process until all the test items have been performed.

In block S306, the comparison module 220 compares the modified test control data with the created test control data to determine if the electronic device 13 passes the test process. If the electronic device 13 passes test process, the procedure goes to block S307. If the electronic device 13 fails test process, the procedure goes to block S308.

In one embodiment, if each of the flag bits in the modified test control data is equal to a corresponding flag bit in the created test control data, and each of the test bits in the modified test control data is different from a corresponding test bit in the created test control data, the comparison module 220 determines that the electronic device 13 passes the test process. For example, as shown in FIG. 4, the created test control data is “1001001010,” if the modified test control data is “010011101,” the comparison module 220 determines that the electronic device 13 passes the test process.

If one of the flag bits in the modified test control data is different from a corresponding flag bit in the created test control data, or one of the test bits in the modified test control data is equal to a corresponding test bit in the created test control data, the comparison module 220 determines that the electronic device 13 fails the test process.

In block S307, the output module 230 outputs a signal indicating success to a display device of the data processing device 11.

In block S308, the output module 230 outputs a signal indicating failure to the display device of the data processing device 11.

Because the flag bits are allocated in the created test control data randomly, it is hard for the test person to obtain the addresses of the test bits in the created test control data. Thus, it is difficult to for the test person to cheat.

It may be understood that the test control system 10 may be installed in the electronic device 13 if the electronic device 13 has the baseboard management controller (BMC) 12, the storage device 15, and the processor 16. Thus, the data processing device 11 may be removed. If the control system 10 is installed in the electronic device 13, the test module 210 may remove the created test control data stored in the FRU storage area 14 of the BMC 12 when test process is complete.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A method for controlling a test process of an electronic device using a data processing device, the method comprising:
creating test control data to test the electronic device, and storing the test control data in a field replacement unit (FRU) storage area of a baseboard management controller (BMC) of the data processing device, the test control data comprising test bits and flag bits, each of the test bits representing a test item of the electronic device;
reading the test control data from the FRU storage area, and selecting a test item of the electronic device sequentially according to the test bits in the test control data;
determining if the electronic device passes the selected test item;
outputting a signal indicating failure if the electronic device fails the selected test item, or implementing a logical NOR operation on a test bit corresponding to the selected test item to obtain modified test control data if the electronic device passes the selected test item;
comparing the modified test control data with the created test control data upon the condition that all the test items of the electronic device have been performed; and
outputting a signal indicating success upon the condition that each of the flag bits in the modified test control data is equal to a corresponding flag bit in the created test control data, and each of the test bits in the modified test control data is different from a corresponding test bit in the created test control data; or
outputting the signal indicating failure upon the condition that one of the flag bits in the modified test control data is different from a corresponding flag bit in the created test control data, or one of the test bits in the modified test control data is equal to a corresponding test bit in the created test control data.

2. The method according to claim 1, wherein the test bits in the test control data comprise at least one test bit which is different from the other test bits.

3. The method according to claim 1, wherein the flag bits in the test control data are not the first bit and the last bit of the test control data.

4. The method according to claim 1, wherein the test bits in the test control data are arranged according to a test order of the test items of the electronic device.

5. The method according to claim 4, wherein the test item of the electronic device is selected sequentially according to the test order of the test items of the electronic device.

6. A data processing device, comprising:
a storage device;
at least one processor; and
one or more modules that are stored in the storage device and are executed by the at least one processor, the one or more modules comprising instructions:
to create test control data to test an electronic device, and storing the test control data in a field replacement unit (FRU) storage area of a baseboard management controller (BMC) of the data processing device, the test control data comprising test bits and flag bits, each of the test bits representing a test item of the electronic device;
to read the test control data from the FRU storage area, and select a test item of the electronic device sequentially according to the test bits in the test control data;
to determine if the electronic device passes the selected test item;
to output a signal indicating failure if the electronic device fails the selected test item, or implement a logical NOR operation on a test bit corresponding to the selected test item to obtain modified test control data if the electronic device passes the selected test item;
to compare the modified test control data with the created test control data upon the condition that all the test items of the electronic device have been performed; and
to output a signal indicating success upon the condition that each of the flag bits in the modified test control data is equal to a corresponding flag bit in the created test control data, and each of the test bits in the modified test control data is different from a corresponding test bit in the created test control data; or
to output the signal indicating failure upon the condition that one of the flag bits in the modified test control data is different from a corresponding flag bit in the created test control data, or one of the test bits in the modified test control data is equal to a corresponding test bit in the created test control data.

7. The data processing device according to claim 6, wherein the test bits in the test control data comprise at least one test bit which is different from the other test bits.

8. The data processing device according to claim 6, wherein the flag bits in the test control data are not the first bit and the last bit of the test control data.

9. The data processing device according to claim 6, wherein the test bits in the test control data are arranged according to a test order of the test items of the electronic device.

10. The data processing device according to claim 9, wherein the test item of the electronic device is selected sequentially according to the test order of the test items of the electronic device.

11. A non-transitory storage medium having stored thereon instructions that, when executed by a processor of a data processing device, causes the processor to perform a method for controlling a test process of an electronic device using the data processing device, the method comprising:
creating test control data to test the electronic device, and storing the test control data in a field replacement unit (FRU) storage area of a baseboard management controller (BMC) of the data processing device, the test control data comprising test bits and flag bits, each of the test bits representing a test item of the electronic device;
reading the test control data from the FRU storage area, and selecting a test item of the electronic device sequentially according to the test bits in the test control data;
determining if the electronic device passes the selected test item;
outputting a signal indicating failure if the electronic device fails the selected test item, or implementing a logical NOR operation on a test bit corresponding to the selected test item to obtain modified test control data if the electronic device passes the selected test item;
comparing the modified test control data with the created test control data upon the condition that all the test items of the electronic device have been performed; and
outputting a signal indicating success upon the condition that each of the flag bits in the modified test control data is equal to a corresponding flag bit in the created test control data, and each of the test bits in the modified test control data is different from a corresponding test bit in the created test control data; or
outputting the signal indicating failure upon the condition that one of the flag bits in the modified test control data is different from a corresponding flag bit in the created test control data, or one of the test bits in the modified test control data is equal to a corresponding test bit in the created test control data.

12. The non-transitory storage medium according to claim 11, wherein the test bits in the test control data comprise at least one test bit which is different from the other test bits.

13. The non-transitory storage medium according to claim 11, wherein the flag bits in the test control data are not the first bit and the last bit of the test control data.

14. The non-transitory storage medium according to claim 11, wherein the test bits in the test control data are arranged according to a test order of the test items of the electronic device.

15. The non-transitory storage medium according to claim 14, wherein the test item of the electronic device is selected sequentially according to the test order of the test items of the electronic device.

16. The non-transitory storage medium according to claim 11, wherein the medium is selected from the group consisting of a hard disk drive, a compact disc, a digital video disc, and a tape drive.
